(19) United States
(12) Patent Application Publication
(10) Pub. No.: US 2023/0194276 A1
(43) Pub. Date: Jun. 22, 2023

(54) DETERMINING NAVIGATION ROUTE BASED ON ENVIRONMENTAL FACTORS

(71) Applicant: RED HAT, INC., Raleigh, NC (US)

(72) Inventor: Michael Tsirkin, Haifa (IL)

(21) Appl. No.: 17/560,220

(22) Filed: Dec. 22, 2021

(51) Int. Cl. G01C 21/34

(52) U.S. Cl. CPC G01C 21/3461

(57) ABSTRACT

A method may include determining, by a navigation system, a route to a destination from an initial position of the navigation system, the route comprising a plurality of edges of a graph representing a map of navigable paths, where each edge represents a path through an environment, the path connecting a first vertex and a second vertex, and each vertex represents at least one of: an endpoint of a path or a junction of two or more paths. Determining the route may include determining an environmental complexity parameter in view of one or more time-varying environmental characteristics of the path at a current time, determining a weight of the edge in view of the environmental complexity parameter, and assigning the weight to the edge, where the route is determined in view of the weight of the edge.

### TECHNICAL FIELD

The present disclosure is generally related to computer systems, and more particularly, to computer systems determining navigation routes based on environmental factors.

### BACKGROUND

A navigation system may process positioning data (provided, e.g., by a satellite-based positioning system and/or by a Navigation via Signals of Opportunity (NAVSOP) system), optionally augmented by motion data (provided, e.g., by a motion measurement device such as accelerometer), to output map information, location data and/or navigation instructions. The navigation system may be implemented on a mobile device, which may move along a route specified by the navigation instructions. The navigation instructions may be suitable for a particular mode of transportation, e.g., walking, running, cycling, or driving.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically depicts a component diagram of an example computer system, in accordance with one or more aspects of the present disclosure;

FIG. 2 illustrates an example map for which navigational routes can be determined based on environmental factors, in accordance with one or more aspects of the present disclosure;

FIG. 3 illustrates an example graph representation of a map for which navigational routes can be determined based on environmental factors, in accordance with one or more aspects of the present disclosure;

FIG. 4 depicts a flow diagram of an example method of determining navigational routes based on environmental factors, in accordance with one or more aspects of the present disclosure;

FIG. 5 depicts a block diagram of an example computer system in accordance with one or more aspects of the present disclosure; and

FIG. 6 depicts a block diagram of an illustrative computing device operating in accordance with the examples of the present disclosure.

### DETAILED DESCRIPTION

Described herein are systems and methods for determining navigation routes based on environmental factors. A vehicle navigation system, for example, may determine a route from the vehicle's current position to a user-specified destination. The navigation system may determine the route according to one or more constraints, e.g., use a shortest path, a fastest path, a path that avoids tool roads or freeways, or avoids or includes a particular path. However, other aspects of the route may be of importance to a user of the navigation system, such as the state of the physical environment along the route. For example, the user may prefer paths that are in shaded areas instead of areas of direct sunlight, particularly if the user is walking. As another example, the user may prefer routes that avoid walking against strong winds.

Aspects of the present disclosure address the above-noted and other deficiencies by providing a navigation system that determines a navigation route based on environmental characteristics at one or more paths on the route. The environmental characteristics can be time-varying characteristics of the environment at or near a path that affect the desirability of the path according to user preferences. The environmental characteristics can include weather characteristics, e.g., sunlight, wind, or temperature, or other characteristics, e.g., scenery. Thus, the environmental characteristics can vary over time. The navigation system can determine the navigation route by optimizing path weights that are based on the environmental characteristics. A user may prefer a path having desirable environmental characteristics, e.g., shade from the sun, over a shorter path having less-desirable environmental characteristics, e.g., direct sun exposure. Thus, the environmental characteristics can be given higher priority (e.g., higher relative weight) than other path characteristics, such as distance or traversal time, in the calculation of path weights, and the navigation system can determine a route that prioritizes the environmental characteristics.

The navigation system can determine the route using a shortest-path algorithm that optimizes based on path weights. Each path weight can be derived from an environmental complexity parameter of the path segments in the route. The navigation system can determine an environmental complexity parameter for each path based on one or more environmental characteristics of the path at a current time, and the weight of the path can be derived from the path's environmental complexity parameter. The environmental complexity parameter can be reflected in an amount of human effort that would be expended along the path. The complexity determined for a path segment can be increased based on environmental characteristics that correspond to increased human effort or are otherwise undesirable according to user preference. The complexity can be decreased based on environmental characteristics that correspond to decreased human effort or are otherwise desirable according to user preference. For example, the environmental complexity parameter can be determined based on a length of a portion of the path that is shaded from direct sunlight, in which case the path's weight can be reduced by the environmental complexity parameter. The shaded portion of the path can be identified using geographical map data that includes the locations and heights of buildings, and determining whether the buildings block the path from the sun based on the position of the sun at a current time. Since the routing algorithm identifies a route by minimizing path weights, the path that is shaded from direct sunlight can be selected by the routing algorithm instead of another path that is not shaded if other factors that contribute to the weight are the same for both paths.

An environmental characteristic can vary over time. For example, sun exposure can vary within each day. An environmental characteristic such as “day or night” which indicates whether sunlight is present can vary at or approximately every 24 hours, which is referred to herein as “circadian variability.” Thus, the environmental complexity parameter can be different at different times or on different days, and so can be based the environmental characteristics that the path has at a “current time.” The current time for a path can be the time at which the route is generated by the navigation system, or, alternatively, a time at which the path is expected to be traversed by a user of the navigation system according to the route. For example, the environmental complexity parameter cab be determined in view of a length of a portion of the path that is exposed to direct sunlight at the current time, wherein the sunlight parameter corresponds to a positive amount of complexity that increases the weight of the edge. A distance or travel time of each path segment can also be included in the route determination, e.g., by including both the environmental complexity parameter and a distance or traversal time in the weight of each path. Thus, for example, if two different paths have the same or similar traversal times, then the path having the lower environmental complexity parameter can be selected and included in the route.

The systems and methods described herein include technical improvements to a computing environment. In particular, aspects of the present disclosure may enhance the performance of a navigation system by causing the navigation system to determine routes that prioritize paths according to environmental characteristics that satisfy user preferences at particular times and locations. Various aspects of the above referenced methods and systems are described in details herein below by way of examples, rather than by way of limitation. The navigation system may determine routes that reduce sun exposure in comparison to alternative routes, as lower sun exposure may be preferred by a user who is walking along a route on a hot day, even if reducing the sun exposure increases the time to reach the destination. Various aspects of the above referenced methods and systems are described in details herein below by way of examples, rather than by way of limitation.

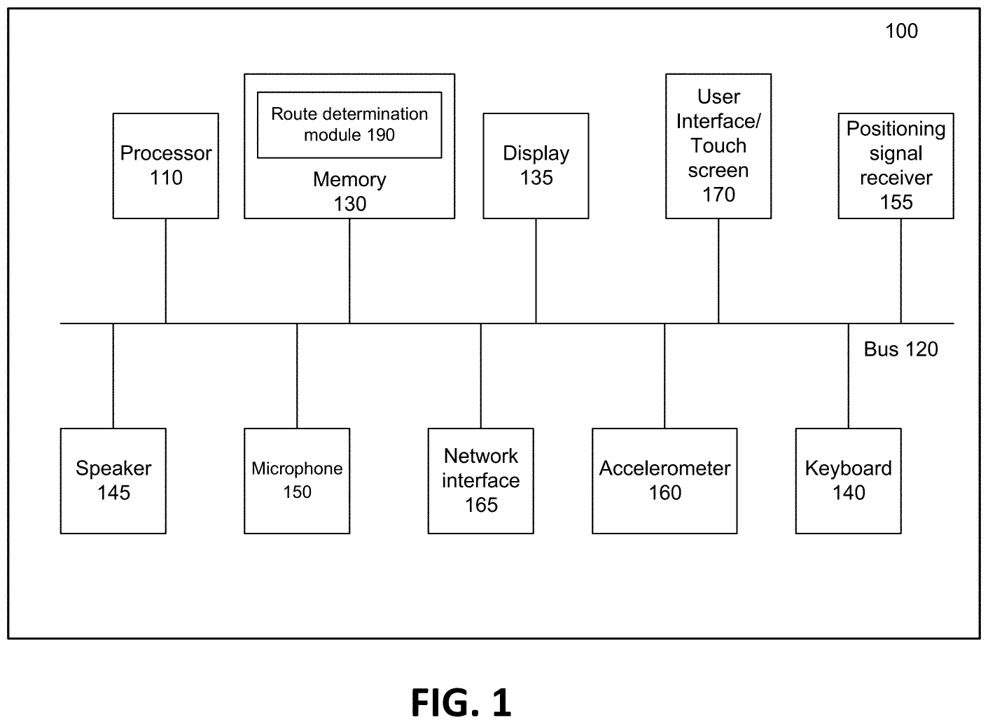

FIG. 1 schematically depicts a high-level component diagram of an example navigation system 100 in accordance with one or more aspects of the present disclosure. In an illustrative example, navigation system 100 may be provided by a computer system comprising a graphical user interface and one or more positioning information input devices. “Computer system” herein shall refer to a data processing system comprising one or more processors, one or more memory devices, and one or more input/output (I/O) interfaces. In certain implementations, navigation system 100 may be provided, for example, by a dedicated dashboard-mountable navigation device, a smart phone, a tablet computer, or a notebook computer.

As schematically illustrated by FIG. 1, navigation system 100 may comprise a processor 110 coupled to a system bus 120. The latter may comprise a data bus, an address bus, and/or a control bus. Processor 110 may be represented by one or more physical processors, including general purpose processors (for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) and/or specialized processors (for example, an application specific integrated circuit (ASIC), a field programmable gate array (FPGA), or a digital signal processor (DSP)).

Other devices coupled to system bus may 120 include a memory 130, a display 135, and a positioning signal receiver 155. The term “coupled” herein shall include electrically connected and/or communicatively coupled via one or more interface devices, adapters and the like.

In an illustrative example, positioning signal receiver 155 may be provided by a satellite navigation signal receiver (e.g., Global Positioning Signal (GPS) receiver or a Global Navigation System (GLONASS) receiver). In another illustrative example, positioning signal receiver 155 may be provided by a NAVSOP signal receiver (e.g., a GSM signal receiver). In certain implementations, navigation system 100 may comprise two or more positioning signal receivers.

In certain implementations, navigation system 100 may further comprise a touch screen input device 170, represented, e.g., by a touch-sensitive and/or presence-sensitive surface of display 135. In an illustrative example, the touch-sensitive surface may comprise a capacity-sensitive layer. In another illustrative example, the touch-sensitive surface may comprise two or more acoustic transducers placed along the horizontal and vertical axes of the display.

In certain implementations, navigation system 100 may further comprise a keyboard 140, a speaker 145, a microphone 150, a motion measurement device (e.g., an accelerometer) 160, and/or a network interface 165, also coupled to system bus 120. Network interface 165 may be provided, for example, by an IEEE 802.11-compliant interface, a cellular interface (such as a 3G or 4G interface, including UMTS, LTE, WiMAX, HSPA, or EV-DO), and/or a Bluetooth interface. Navigation system 100 may implement a network protocol stack, such as TCP/IP, to support communications over the network interface 165.

Memory 130 may include one or more volatile memory devices (for example, RAM chips), one or more non-volatile memory devices (for example, ROM or EEPROM chips), and/or one or more secondary memory devices (for example, a storage memory device, such as an optical or magnetic disk). The storage memory may include a non-transitory computer-readable storage medium on which may be stored instructions implementing the methods described herein.

In certain implementations, memory 130 may store instructions of various code modules employed by navigation system 100, including instructions of a code module 190 for determining navigation routes, in accordance with one or more aspects of the present disclosure. Alternatively, the methods described herein may be implemented by discrete hardware components or may be integrated in the functionality of other hardware components such as ASICS, FPGAs, DSPs or similar devices. In addition, the methods described herein may be implemented by firmware modules or functional circuitry within hardware devices. Further, the methods described herein may be implemented in any combination of hardware devices and software components.

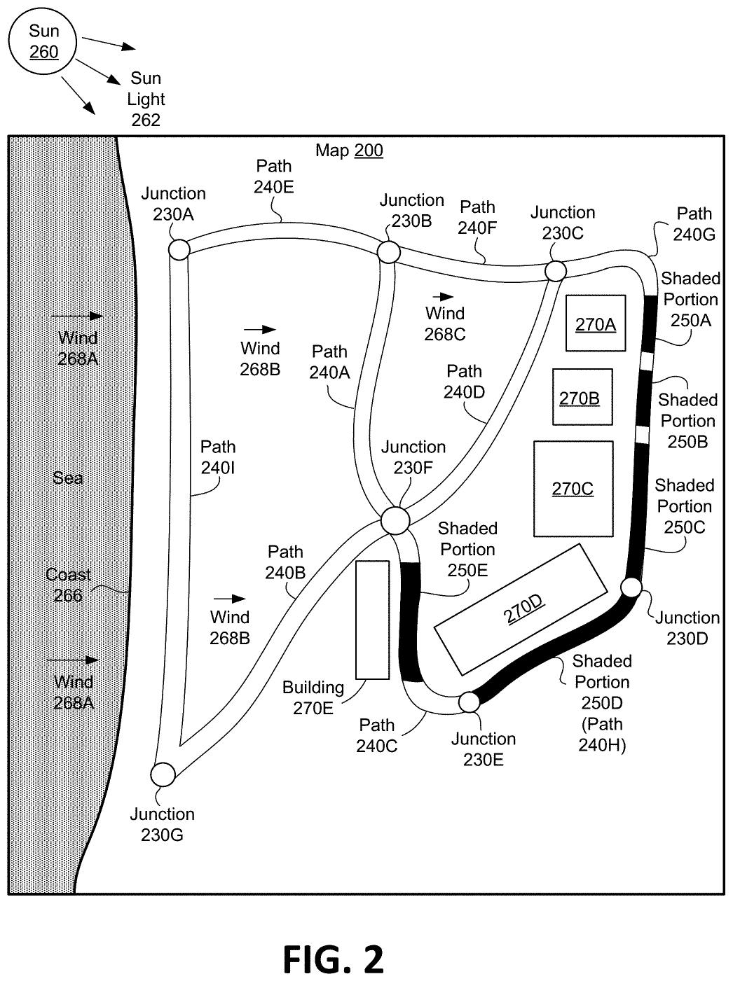

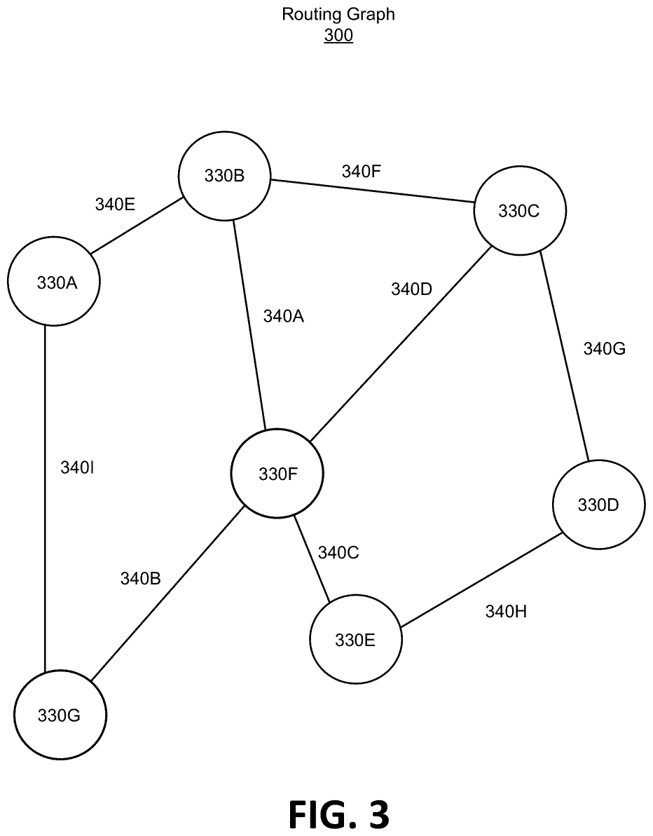

FIG. 2 illustrates an example map 200 for which navigational routes can be determined based on environmental factors, in accordance with one or more aspects of the present disclosure. Navigation system 100 may be designed to represent the map 200 of navigable paths 240 by a graph 300 comprising a plurality of vertices linked by a plurality of edges, as schematically illustrated by FIG. 3. A vertex 330 of the graph 300 may represent an endpoint of a path 240 and/or a junction 230 of two or more paths 240. An edge 340 of the graph may represent a path 240 connecting two vertices 330. In certain implementations, the edges 340 may be unidirectional or bi-directional representing, respectively, unidirectional or bi-directional navigable paths 240.

In certain implementations, a weight may be assigned to an edge 340 to represent, e.g., the distance between the respective path endpoints or junctions 230. Alternatively, a weight assigned to an edge 340 may represent a time period necessary to traverse the path 240 represented by the edge 340 at a defined vehicle speed (e.g., at a maximum allowed speed). Alternatively, a weight assigned to an edge 340 may represent an environmental complexity associated with traversing the path 240 represented by the edge 340 at a particular time. Alternatively, a weight assigned to an edge 340 may represent a user preference with respect to including the path 240 represented by the edge into a route. Alternatively, a weight assigned to an edge 340 may represent a cost involved in traversing the path 240 represented by the edge (e.g., a toll to be paid).

Navigation system 100 may receive, e.g., via graphical user interface presented on the touch screen 170 or network interface 165, a destination point. Responsive to determining the current position based on the navigational signal received by positioning signal receiver 155, navigation system 100 may calculate a route from the current position, e.g., a junction 230 represented by a vertex 330, to the specified destination, which may be another junction 230 represented by a vertex 330, as schematically illustrated by FIGS. 2 and 3. The route may be represented by a subset of navigation graph 300, and may comprise a plurality of vertices 330 linked by a plurality of edges 340 (which may represent a plurality of junctions 230 linked by a plurality of paths 240).

Navigation system 100 may employ a routing method yielding a route optimizing a pre-determined or user-specified optimization criterion (e.g., a path of least environmental complexity, shortest path, or a fastest path). The optimization may be performed in view of one or more pre-determined or user-specified constraints (e.g., favor particular environmental characteristics, avoid particular environmental characteristics, avoid toll roads, avoid freeways, avoid a particular path, or include a particular path). In an illustrative example, one or more pre-determined or user-specified constraints may be represented by weights assigned to a plurality of edges 340 of the routing graph 300, and the routing method may be based on Dijkstra's algorithm producing the path of least environmental complexity, shortest path, fastest path, or a combination thereof over a graph with non-negative edge weights. In another illustrative example, certain heuristics may be used to minimize the computational complexity of the routing method, and hence sub-optimal routes may be yielded. In certain implementations, navigation system 100 may be programed to select the routing method to be employed from two or more routing methods, e.g., based on the characteristics of the routing graph and/or the user preferences. Although particular examples described herein refer to junctions 230 and paths 240, the routing method may use the graph 300 representation of the map to compute routes, by using the respective vertices 330 that correspond to the junctions 230 and the respective edges 340 that correspond to the paths 240.

Alternatively, navigation system 100 may transmit a routing request comprising the current position and destination information to an external computer system over a wireless network. In certain implementations, the routing request may further comprise a pre-determined or user-specified optimization criterion and/or one or more pre-determined or user-specified constraints. The external computer system may perform the routing method, which may produce the path of least environmental complexity, shortest path, fastest path, or a combination thereof. The external computer system may send a response comprising a suggested route. Navigation system 100 may further receive, from the external computer system, the response corresponding to the routing request and comprising a suggested route to the destination.

Navigation system 100 may present the determined route to the user via a graphical user interface on the display 135 and/or audio output device 145. Navigation system 100 may further continuously determine its own current position and present the current position to the user via the graphical user interface on the display 135.

In certain implementations, navigation system 100 may implement a method for determining routes based on environmental characteristics at one or more paths on the route. In an illustrative example, a user may request that the navigation system 100 provide walking directions to a destination 230B from an initial position 230C. The user may further specify preferences indicating that the navigation system is to avoid, to the extent possible for the given constraints, paths via which the user would walk into the wind, e.g., into the direction from which the wind is blowing. In the example of FIG. 2, wind 268 blows from the sea 264 in the west across the coast 266 to the east.

There is a path 240F from junction 230C to junction 230B, which is referred to herein as a first example route. However, traversing the path 240F, which is from east to west, would involve moving directly, or nearly directly, in the direction from which the wind 268A is blowing (which is from west to east). A second example route, from junction 230C through junction 230F to junction 340B, traverses the diagonal path 240D in to the southwest, the traverses the vertical path 240A to the north to arrive at junction 230B. Traversing the path 240D involves moving indirectly toward the direction from which the wind 268A is blowing (e.g. at approximately a 45 degree angle to the wind), so the wind resistance is not as strong along path 240D as along path 240F. Further, traversing the path 240A involves moving in a direction that is approximately perpendicular to the direction from which the wind 268A is blowing, so the wind resistance is not as strong along path 240A as along path 240F.

The wind direction is an example of an environmental characteristic. Thus, the second example route uses less environmental complexity than the first example route. Navigation system 100 can determine that the second example route has a lower environmental complexity than the first example route by evaluating path weights that are determined based on an environmental complexity parameter value calculated for each path, which can include whether the route along the path is into the wind (as in path 240F), or a value based on the relative angle of the wind to the route along the path at the current time. The wind-based environmental complexity parameter can also be determined based on a speed and direction of the wind relative to the direction of travel along the path at the current time. Thus, each path weight can be based on an environmental complexity parameter determined from one or more environmental characteristics of the path at a current time. Each path weight can be further based on a distance or traversal time of the path, so that both the environmental complexity and the distance or traversal time can be optimized.

Since shortest paths algorithms ordinarily optimize for routes having the lowest path weights, the environmental complexity parameter can be a positive value to indicate an increased amount of complexity (e.g., an undesirable environmental condition according to user preferences or other criteria), or a negative value to indicate a decreased amount of complexity (e.g., a desirable environmental condition according to user preferences or other criteria). Thus, if a path against the wind is undesirable according to user preferences or other criteria (e.g. whether the current temperature is below a threshold value), then the environmental complexity parameter may have a positive value (thereby increasing the path's weight) for a path that is against the wind, or a negative value (thereby decreasing the path's weight) for a path that is in the same direction the wind is blowing. For example, a path such as path 240 that is perpendicular to the direction of the wind 268 may have a wind-based environmental complexity parameter of 0, or other value that is less than a parameter value for a path directly into the wind but greater than a parameter value for a path in the same direction as the wind at the current time. The navigation system 100 can select the path that optimizes the path weights and present the selected path to the user via a user interface on a touch screen 170 and/or display 135.

In another illustrative example, a user may request that the navigation system 100 provide walking directions to a destination 230F from an initial position 230C. The user may further specify preferences indicating that the navigation system is to avoid direct sunlight 262 from the Sun 260 to the extent possible for the given constraints, e.g., select a path having shade to the extent possible. There is a path 240D from junction 230C to junction 230F, which is referred to herein as a first example route. However, the entire length of the path 240D is exposed to direct sunlight 262 at a current time, such as the time at which the navigation system 100 determines the route. A second example route, from junction 230C through junctions 230D and 230E to 230F, has shaded portions 250A, 250B, 250C, 240D, 240H. The length of the portions of the second example route that are exposed to direct sunlight at the current time (e.g., the lengths of the non-shaded portions of paths 240G, 240H, and 240C) is less than the length of first example route that is exposed to direct sunlight (e.g., the entire length of path 240A).

The shaded portions 240A, 240B, 250C, 250$ (the length of path 240H), 250E are not exposed to direct sunlight 262 from the Sun 260 because buildings 270A, 270B, 270C, 270D, 270E block the sunlight 262 from directly reaching the shaded portions (e.g., the Sun 260 is not visible from the shaded portions of the paths because it is blocked by the buildings). The non-shaded portions of the second example route, which are exposed to direct sunlight at the current time, are the portions of paths 240G, 240H, 240C that are not shaded. As can be seen, the length of the non-shaded portions of the second route (the paths 240G, 240H, 240C) is less than the length of the non-shaded portion of the first route (the path 240A).

The amount of direct sunlight is an example of an environmental characteristic. Thus, the second example route uses less environmental complexity than the first example route. Navigation system 100 can determine that the second example route has a lower environmental complexity than the first example route by evaluating path weights that are determined based on an environmental complexity parameter value calculated for each path, which can be based on the length of the portion(s) of the path that are exposed to direct sunlight.

As described above, the environmental complexity parameter can be a positive value to indicate an increased amount of complexity (e.g., an undesirable environmental condition according to user preferences or other criteria), or a negative value to indicate a decreased amount of complexity (e.g., a desirable environmental condition according to user preferences or other criteria). Thus, if a path exposed to direct sunlight is undesirable according to user preferences or other criteria (e.g. whether the current temperature is above a threshold value), then the environmental complexity parameter may be derived from, e.g., a sum of, a positive value for each portion of a path that is exposed to direct sunlight, or a negative value for each portion of the path that is not exposed to direct sunlight (e.g., is shaded from direct sunlight). For example, path 240H, which is entirely shaded from direct sunlight, may have a negative sunlight-based environmental complexity parameter, which decreases the weight of the path. Path 240D, which is entirely exposed to direct sunlight, may have a positive sunlight-based environmental complexity parameter, which increases the weight of the path. Path 240C, of which approximately half the length is shaded from direct sunlight, may have a sunlight-based environmental complexity parameter between the negative value of path 250D and the positive value of path 240D. The navigation system 100 can select the path that optimizes the path weights and present the selected path to the user via a user interface on a touch screen 170 and/or display 135.

Although particular environmental characteristics are described in the examples above, any suitable environmental characteristics may be used to determine the weights of paths 240. For example, the environmental complexity parameter can be derived from weather conditions such as the amount of rain or snow on a path (which may vary over time), the temperature on a path (e.g., the temperature may vary with the amount of sun exposure on the path). As another example, the environmental complexity parameter can be derived from an indication of how scenic the path is. The scenic indication may be an environmental complexity parameter that has a negative value to indicate that the path is scenic. The value of the scenic complexity parameter may indicate the degree of scenicness of the path. The scenic indication may be determined based on a number of photos of the location that have been shared on social media or are identified by an Internet search, for example. Further, a path weight can be determined based on a plurality of environmental complexity parameters, each of which may be calculated from a different environmental characteristic. For example, a path weight can be determined from a wind complexity parameter and a sunlight complexity parameter. The weight can be a weighted sum of the wind and sunlight complexity parameters, in which each parameter is weighted by a respective coefficient.

The values of the respective coefficients can be determined from user preferences. For example, a user may indicate that avoiding direct sunlight is twice as important as avoiding strong winds, in which the sunlight parameter coefficient may have a value twice that of the wind coefficient parameter to indicate that the complexity for sunlight is twice the complexity for strong winds.

Alternatively or additionally, the values of the respective coefficients can be parameters of a heuristic model based on empirically determined data, e.g., the routes that a user prefers in a range of weather conditions. If the user travels on paths that have strong winds three times more often as on paths that have direct sunlight, even if the path having strong winds result in a route having longer total travel time, then the sunlight parameter coefficient may have a value three times the value of the wind coefficient to indicate that the complexity for sunlight is three times the complexity for strong winds.

In other embodiments, the coefficients may be learned by a machine machine-learning model, which may be trained using information about the users travels such as that described above. The model may be any suitable machine learning model or heuristic model, such as a Linear Regression, Bayes, Random Forest, Support Vector Classifier, Decision Tree, Gradient Boosted Tree, K-Nearest Neighbors model, or the like. The model may be implemented by one or more neural networks. The model, once trained on historic training data such as that described above, may be used to determine the coefficient values of each term of a linear combination (e.g., weighted sum) that contributes to the weight of a path.

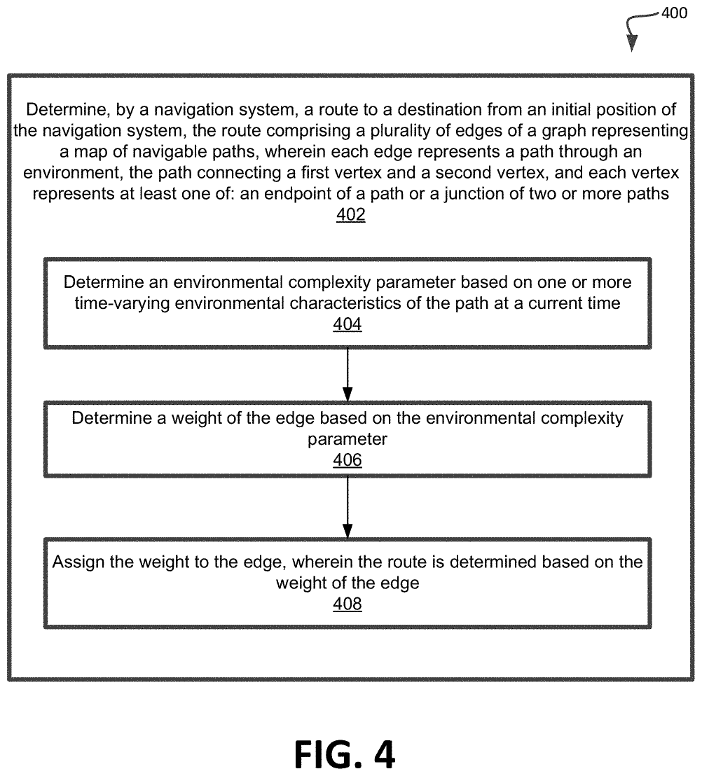

FIG. 4 depicts a flow diagram of an example method 400 of determining navigational routes based on environmental factors, in accordance with one or more aspects of the present disclosure. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 400 may be synchronized (e.g., using semaphores, critical sections, and/or other thread synchronization mechanisms). Alternatively, the processes implementing method 400 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processor of a navigation system 100 as shown in FIG. 1 or by an executable code of a host machine (e.g., host operating system or firmware), a virtual machine (e.g., guest operating system or virtual firmware), an external device (e.g., a PCI device), other executable code, or a combination thereof.

Method 400 may be performed by processing devices of a navigation system, which may be the navigation system 100, a server device, and/or a client device. Method 400 may begin at block 402. At block 402, a navigation system may determine a route to a destination from an initial position of the navigation system, the route comprising a plurality of edges of a graph representing a map of navigable paths, wherein each edge represents a path through an environment, the path connecting a first vertex and a second vertex, and each vertex represents at least one of: an endpoint of a path or a junction of two or more paths. To perform block 402, the navigation system may perform blocks 404-408.

At block 404, the navigation system may determine an environmental complexity parameter based on one or more environmental characteristics of the path at a current time. The current may be a time at which a current position of the navigation system corresponds to a position associated with the path, e.g., a time at which the navigation system is expected to be located on the path, which may be a sum of the time at which navigation begins and a time at which the navigation system is expected to arrive at the path according to the route. The navigation system may be, for example, carried by the user, e.g., as a wearable device or other mobile device, or may be a component of a vehicle.

At block 406, the navigation system may determine a weight of the edge based on the environmental complexity parameter. The weight of an edge may be based on the length of the path. The navigation system may determine a path length based on a distance between the endpoint or junction represented by the first vertex and the endpoint or junction represented by the second vertex. The weight of the edge may then be further determined from the path length. The navigation system may determine a path traversal time in based on the path length and a speed of travel associated with the edge, and the weight of the edge may be based on the path traversal time. Thus, the navigation system may optimize a combination (e.g., sum) of the environmental complexity parameter(s) that contribute to the weight and a path length or speed of travel that also contributes to the weight. The relative contributions of the environmental complexity parameter(s), path length, and/or speed may be specified by coefficients. For example, the weight of the path may be a linear combination of the environmental complexity parameter(s), path length, and/or speed, in which the coefficients by which the terms of the linear combination is multiplied are determined as described above, e.g., using user preferences, an empirically-derived heuristic model, or a machine-learning model.

As described above with respect to FIG. 2, the environmental characteristics may include sunlight, in which case the environmental complexity parameter may be a sunlight parameter determined in based on a length of a portion of the path that is shaded from direct sunlight at the current time. The sunlight parameter may correspond to a negative amount of complexity that reduces the weight of the edge. The environmental complexity parameter is determined in view of a difference between a length of the path and a length of a portion of the path that is shaded from direct sunlight by a physical object at the current time. The navigation device may identify, using map data, the physical object, such that the physical object is within a threshold distance of the path and has a size sufficient to block a portion of the path from direct sunlight at the current time. The environmental complexity parameter may be determined based on a length of the portion of the path that is blocked from direct sunlight. For example, the environmental complexity parameter may be determined by subtracting the length of the blocked (shaded) portion of the path from the length of the path.

The signs or values of particular environmental complexity parameters can depend on the values of other environmental parameters. For example, on a cold day, e.g., when the temperature is below a threshold value, a path exposed to direct sunlight may have a lower environmental complexity parameter if sunlight is more desirable in cold weather (as may be the case by default, or if so indicated by user preferences). As another example, on a hot day, e.g., when the temperature is above a threshold value, a path having a direction into the wind may have a lower environmental complexity parameter if wind is more desirable in hot weather. Thus, the environmental characteristics may include temperature, and the sunlight parameter may be reduced if the temperature is less than a temperature threshold.

The environmental characteristics may include wind, in which case the environmental complexity parameter may be a wind parameter determined based on a comparison between a direction toward which the wind is blowing at the current time and a direction of travel along the path. The wind parameter may be determined in view of a speed and direction of the wind relative to the direction of travel along the path at the current time. The wind parameter may correspond to a negative amount of complexity that reduces the weight of the edge if the direction toward which the wind is blowing at the current time is within a threshold number of degrees of a direction of travel along the path. The threshold number of degrees may be, e.g., 5 degrees, 10 degrees, or 20 degrees. Alternatively, the threshold number of degrees may be a parameter learned by a machine learning model as described above with respect to FIG. 2. As another example, the wind parameter corresponds to a positive amount of complexity if the direction toward which the wind is blowing at the current time is within a threshold number of degrees of a direction opposite a direction of travel along the path. The threshold number of degrees may be, e.g., 5 degrees, 10 degrees, or 20 degrees, or a number learned by a machine learning model

The wind parameter may be zero if the direction toward which the wind is blowing at the current time is within the threshold number of degrees of being perpendicular to the direction of the path. The threshold number of degrees may be, e.g., 5 degrees, 10 degrees, or 15 degrees, or a number learned by a machine learning model. The direction toward which wind is blowing at the current time is determined using weather data received from an online weather service, for example. The environmental characteristics further include temperature as described above. The navigation system can reduce the wind parameter if the temperature is less than a temperature threshold.

At block 408, the navigation system may assign the weight to the edge, wherein the route is determined based on the weight of the edge. Responsive to completing the operations described herein above with references to block 408, the method 400 may terminate.

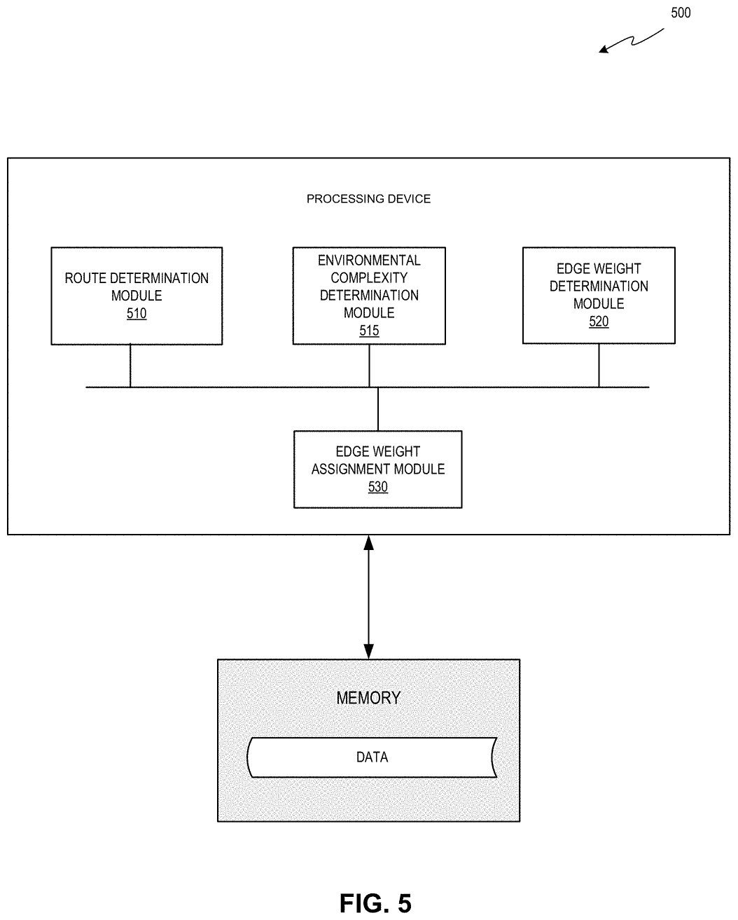

FIG. 5 depicts a block diagram of a computer system 500 operating in accordance with one or more aspects of the present disclosure. Computer system 500 may be the same or similar to navigation system 100 of FIG. 1, and may include one or more processors and one or more memory devices. In the example shown, computer system 500 may include a route determination module 510, an environmental complexity determination module 515, an edge weight determination module 520, and an edge weight assignment module 530.

Route determination module 510 may enable a processor to determine a route to a destination from an initial position of the navigation system, the route comprising a plurality of edges of a graph representing a map of navigable paths, wherein each edge represents a path through an environment, the path connecting a first vertex and a second vertex, and each vertex represents at least one of: an endpoint of a path or a junction of two or more paths. Route determination module 510 may invoke or include environmental complexity determination module 515, edge weight determination module 520, and edge weight assignment module 530.

Environmental complexity determination module 515 may enable the processor to determine an environmental complexity parameter in accordance with one or more environmental characteristics of the path at a current time. The environmental characteristics may include sunlight, and the environmental complexity parameter comprises a sunlight parameter determined in view of a length of a portion of the path that is shaded from direct sunlight at the current time. The sunlight parameter corresponds to a negative amount of complexity that reduces the weight of the edge.

The environmental characteristics may include wind, and the environmental complexity parameter may be a wind parameter determined in view of a comparison between a direction toward which the wind is blowing at the current time and a direction of travel along the path. The wind parameter may be determined in accordance with a speed and direction of the wind relative to the direction of travel along the path at the current time. The wind parameter may correspond to a negative amount of complexity that reduces the weight of the edge if the direction toward which the wind is blowing at the current time is within a threshold number of degrees of a direction of travel along the path. Edge weight determination module 520 may enable the processor to a determine weight of the edge in accordance with the environmental complexity parameter. Edge weight assignment module 530 may cause the processor to assign the weight to the edge, wherein the route is determined in view of the weight of the edge.

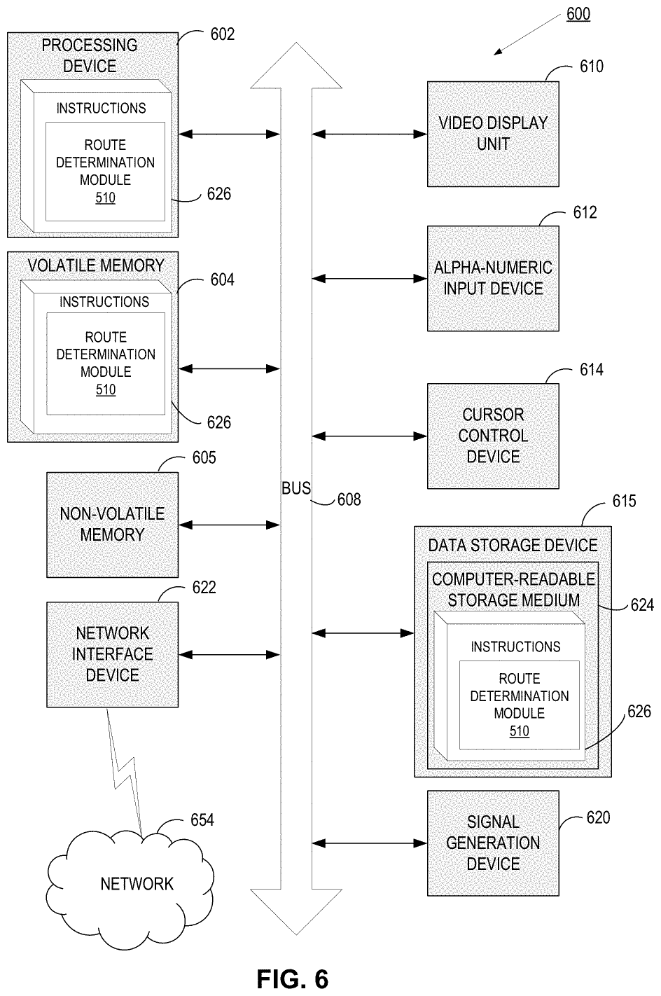

FIG. 6 depicts a block diagram of a computer system operating in accordance with one or more aspects of the present disclosure. In various illustrative examples, computer system 600 may correspond to navigation system 100 of FIG. 1. Computer system 600 may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical environment, but requests for a hard disk or memory may be managed by a virtualization layer of a computing device to translate these requests to the underlying physical computing hardware resources. This type of virtualization results in multiple VMs sharing physical resources.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for implementing method 400.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “determining,” “deriving,” “encrypting,” “creating,” “generating,” “using,” “accessing,” “executing,” “obtaining,” “storing,” “transmitting,” “providing,” “establishing,” “receiving,” “identifying,” “initiating,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 400 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
determining, by a navigation system, a route to a destination from an initial position of the navigation system, the route comprising a plurality of edges of a graph representing a map of navigable paths, wherein each edge represents a path through an environment, the path connecting a first vertex and a second vertex, and each vertex represents at least one of: an endpoint of a path or a junction of two or more paths, wherein determining the route comprises:
determining an environmental complexity parameter of the path in view of one or more time-varying environmental characteristics of the path at a current time;
determining a weight of the edge in view of the environmental complexity parameter; and
assigning the weight to the edge, wherein the route is determined in view of the weight of the edge.

2. The method of claim 1, wherein the current time comprises a time at which a current position of the navigation system corresponds to a position associated with the path.

3. The method of claim 1, further comprising:
determining a path length in view of a distance between the endpoint or junction represented by the first vertex and the endpoint or junction represented by the second vertex,
wherein the weight of the edge is further determined in view of the path length.

4. The method of claim 3, further comprising:
determining a path traversal time in view of the path length and a speed of travel associated with the edge, wherein the weight of the edge is further determined in view of the path traversal time.

5. The method of claim 1, wherein the environmental characteristics include sunlight, and wherein the environmental complexity parameter comprises a sunlight parameter determined in view of a length of a portion of the path that is shaded from direct sunlight at the current time, wherein the sunlight parameter corresponds to a negative amount of complexity that reduces the weight of the edge.

6. The method of claim 5, wherein the environmental complexity parameter is determined in view of a difference between a length of the path and a length of a portion of the path that is shaded from direct sunlight by a physical object at the current time.

7. The method of claim 6, further comprising:
identifying, using map data, the physical object, wherein the physical object is within a threshold distance of the path and has a size sufficient to block a portion of the path from direct sunlight at the current time, and wherein the environmental complexity parameter is determined based on a length of the portion of the path that is blocked from direct sunlight.

8. The method of claim 5, wherein the environmental characteristics further include temperature, the method further comprising:
reducing the sunlight parameter if the temperature is less than a temperature threshold.

9. The method of claim 1, wherein the environmental characteristics include wind, and wherein the environmental complexity parameter comprises a wind parameter determined in view of a comparison between a direction toward which the wind is blowing at the current time and a direction of travel along the path.

10. The method of claim 9, wherein the wind parameter is determined in view of a speed and direction of the wind relative to the direction of travel along the path at the current time.

11. The method of claim 9, wherein the wind parameter corresponds to a negative amount of complexity that reduces the weight of the edge if the direction toward which the wind is blowing at the current time is within a threshold number of degrees of a direction of travel along the path.

12. The method of claim 9, wherein the wind parameter corresponds to a positive amount of complexity if the direction toward which the wind is blowing at the current time is within a threshold number of degrees of a direction opposite a direction of travel along the path.

13. The method of claim 9, wherein the wind parameter is zero if the direction toward which the wind is blowing at the current time is within a threshold number of degrees of being perpendicular to the direction of the path.

14. The method of claim 9, wherein the direction toward which wind is blowing at the current time is determined using weather data.

15. The method of claim 9, wherein the environmental characteristics further include temperature, the method further comprising:
reducing the wind parameter if the temperature is less than a temperature threshold.

16. The method of claim 1, wherein each environmental characteristic has at least circadian variability.

17. The method of claim 1, wherein the current time comprises a date.

18. A system comprising:
a memory device comprising a group of memory units; and
a processing device, operatively coupled to the memory device, to perform operations comprising:
determining, by a navigation system, a route to a destination from an initial position of the navigation system, the route comprising a plurality of edges of a graph representing a map of navigable paths, wherein each edge represents a path through an environment, the path connecting a first vertex and a second vertex, and each vertex represents at least one of: an endpoint of a path or a junction of two or more paths, wherein determining the route comprises:
determining an environmental complexity parameter of the path in view of one or more time-varying environmental characteristics of the path at a current time;
determining a weight of the edge in view of the environmental complexity parameter; and
assigning the weight to the edge, wherein the route is determined in view of the weight of the edge.

19. The system of claim 18, wherein the current time comprises a time at which a current position of the navigation system corresponds to a position associated with the path.

20. A non-transitory machine-readable storage medium storing instructions that cause a processing device to:
determine, by a navigation system, a route to a destination from an initial position of the navigation system, the route comprising a plurality of edges of a graph representing a map of navigable paths, wherein each edge represents a path through an environment, the path connecting a first vertex and a second vertex, and each vertex represents at least one of: an endpoint of a path or a junction of two or more paths, wherein determining the route comprises:
determining an environmental complexity parameter of the path in view of one or more time-varying environmental characteristics of the path at a current time;
determining a weight of the edge in view of the environmental complexity parameter; and
assigning the weight to the edge, wherein the route is determined in view of the weight of the edge.
